(19) United States
(12) Patent Application Publication
(10) Pub. No.: US 2018/0244023 A1
(43) Pub. Date: Aug. 30, 2018

(54) POLYIMIDE PRECURSOR SOLUTION AND METHOD OF FORMING POROUS POLYIMIDE FILM

(71) Applicant: FUJI XEROX CO., LTD., Tokyo (JP)

(72) Inventors: Katsumi NUKADA, Kanagawa (JP); Tomoya SASAKI, Kanagawa (JP); Kana MIYAZAKI, Kanagawa (JP); Takashi IMAI, Kanagawa (JP)

(73) Assignee: FUJI XEROX CO., LTD., Tokyo (JP)

(21) Appl. No.: 15/782,263

(22) Filed: Oct. 12, 2017

(30) Foreign Application Priority Data
Feb. 24, 2017 (JP) 2017-033922

(51) Int. Cl. B32B 27/28; C08L 79/08

(52) U.S. Cl. CPC B32B 27/281; C08G 73/1007; C08L 79/08

(57) ABSTRACT

A polyimide precursor solution includes resin particles, an aqueous solvent including water, a polyimide precursor, an organic amine compound, and a water-soluble nonionic surfactant.

### CROSS-REFERENCE TO RELATED APPLICATIONS

This application is based on and claims priority under 35 USC 119 from Japanese Patent Application No. 2017-033922 filed Feb. 24, 2017.

### BACKGROUND

### 1. Technical Field

The present invention relates to a polyimide precursor solution and a method of forming a porous polyimide film.

### 2. Related Art

A polyimide resin is a material having excellent properties such as mechanical strength, chemical stability, and heat resistance, and a porous polyimide film having these properties has attracted attention.

A polyimide precursor is generally dissolved in a polar aprotic solvent (for example, N-methylpyrrolidone and N,N-dimethylacetamide) and it is difficult to dissolve in water as it is. In order to obtain a polyimide precursor solution dissolved in a solution including water, for example, a polyimide precursor is neutralized with an inorganic base or an organic base to be dissolved. In a case where a polyimide precursor solution in which resin particles are dissolved is assumed as the polyimide precursor solution dissolved in an aqueous solution including water, aggregation of the resin particles is likely to occur, and thereby it may be difficult to obtain a polyimide precursor solution in which the resin particles in a nearly uniform state are dispersed. In addition, in a case where a porous polyimide film is formed by using a polyimide precursor solution having a low dispersion state of the resin particles, it is understood that the area ratio of pores on the surface of the obtained porous polyimide film tends to decrease.

### SUMMARY

A polyimide precursor solution including:

resin particles;

an aqueous solvent including water;

a polyimide precursor;

an organic amine compound; and

a water-soluble nonionic surfactant.

### BRIEF DESCRIPTION OF THE DRAWING

An exemplary embodiments of the present invention will be described in detail based on the following FIGURE, wherein:

FIG. 1 is a schematic view illustrating an aspect of a porous polyimide film obtained by using a polyimide precursor solution of an exemplary embodiment.

### DETAILED DESCRIPTION

Hereinafter, the exemplary embodiment which is an example of the present invention will be described.

### Polyimide Precursor Solution and Method of Forming Porous Polyimide Film

The polyimide precursor solution according to the exemplary embodiment includes an aqueous solvent including water (hereinafter, may be simply referred to as “aqueous solvent”), resin particles (hereinafter, may be simply referred to as “resin particles”) which are not dissolved in an aqueous solvent, an organic amine compound, polyimide precursor, and a water-soluble nonionic surfactant.

The method of forming a porous polyimide film according to the exemplary embodiment includes a first step of forming a coated film by applying the polyimide precursor solution including the aqueous solvent, the resin particles which are not dissolved in the aqueous solvent, the organic amine compound, the polyimide precursor, and the water-soluble nonionic surfactant, and then drying the coated film so as to form a film including the polyimide precursor and the resin particles; and a second step of forming a polyimide film by heating the film and imidizing the polyimide precursor, which includes a treatment of removing the resin particles.

In the related art, a porous polyimide film including a porous polyimide film has been proposed.

The porous polyimide film is obtained using a polyimide precursor solution including, for example, a polar aprotic solvent (for example, N-methylpyrrolidone (hereinafter, may be referred to as “NMP”)), and a polyimide precursor and particles (for example, silica particles and the like) which are dissolved in N,N-dimethylacetamide (hereinafter, may be referred to as “DMAc”). When the substrate is coated with the polyimide precursor solution, the coated film tends to repel, the obtained porous polyimide film is likely to be unevenness, and the uniformity tends to be deteriorated.

On the other hand, the polyimide precursor is usually dissolved in a so-called polar aprotic solvent such as NMP and DMAc, and it is difficult to dissolve in water as it is. In order to obtain a polyimide precursor solution including the polyimide precursor dissolved in the aqueous solution including water, the polyimide precursor is neutralized with, for example, an inorganic base or an organic base, and is dissolved as carboxylate. Since this polyimide precursor solution includes a large amount of polyimide precursor salt, aggregation of the resin particles is likely to occur due to the polyimide precursor salt when the resin particles are included in the polyimide precursor solution. For this reason, it may be difficult to obtain a polyimide precursor solution in which the resin particles are dispersed in a nearly uniform state.

When applying the polyimide precursor solution in a state where the resin particles in the polyimide precursor solution are not sufficiently dispersed, the resin particles are more likely to aggregate when the coated film is dried, and the porous polyimide film tends to become uneven.

Also, moisture evaporates from the coated film surface during the drying of the coated film. At this time, when the moisture in the coated film moves to the coated film surface, the polyimide precursor easily diffuses with polyimide precursor salt. Therefore, the proportion of the polyimide precursor tends to increase on the coated film surface, and the area ratio of the pores on the surface of the obtained porous polyimide film tends to decrease.

As such, in a case where the porous polyimide film is obtained by using a polyimide precursor solution in which the resin particles are dispersed, it has been found that the area ratio of the pores on the surface of the porous polyimide film is likely to decrease.

In contrast, in the polyimide precursor solution according to the exemplary embodiment, in a case where the porous polyimide film is obtained by using the polyimide precursor solution having the above-described configuration, the area ratio of the pores on the surface of the porous polyimide film is improved. In addition, in the method of forming a porous polyimide film according to the exemplary embodiment, in a case where the porous polyimide film is formed through the above-described steps by using the polyimide precursor solution according to the exemplary embodiment, the area ratio of the pores on the surface of the porous polyimide film is improved. The reason for this is not clear, but it is presumed as follows.

First, by adding a water-soluble nonionic surfactant to the polyimide precursor solution including the aqueous solvent, the resin particles, the organic amine compound, and the polyimide precursor, the surface of the resin particle is coated with the water-soluble nonionic surfactant. As a result, it is considered that the dispersibility of the resin particles in polyimide precursor solution is improved by the effect of preventing the resin particles from aggregating, which is attributable to the ionized polyimide precursor salt.

Further, the dispersibility of the resin particles is improved by adding the water-soluble nonionic surfactant to the above polyimide precursor solution, and thus when drying the coated film, when the coated film is dried, the polyimide precursor is prevented from being diffused with the polyimide precursor salt and the moisture movement. As a result, it is considered that the proportion of the polyimide precursor on the coated film surface is prevented.

In addition, the water-soluble nonionic surfactant easily moves (migrates) the polyimide precursor to the film surface in the imidizing process with the process of imidizing the polyimide precursor. For this reason, it is considered that the area ratio of the pores on the surface of the polyimide film after imidization increases as compared with a case where the water-soluble nonionic surfactant is not included.

Accordingly, it is considered that when the water-soluble nonionic surfactant is used, the area ratio of the pores on the surface of the obtained porous polyimide is improved by an effect of improving the dispersibility of the resin particles and an action that the water-soluble nonionic surfactant easily moves to the polyimide film surface through the imidizing process.

From the above description, it is presumed that the porous polyimide film obtained by the polyimide precursor solution according to the exemplary embodiment and the method of forming a porous polyimide film according to the exemplary embodiment have improved area ratio of the pores on the surface.

Note that, as described above, in the polyimide precursor solution according to the exemplary embodiment, and the method of forming a porous polyimide film according to the exemplary embodiment, an aqueous solvent is used. Thus, the obtained porous polyimide film may easily obtain the following advantages. The following advantages are presumed as follows.

In the related art, a porous polyimide film is obtained which is formed by using a polyimide precursor solution in which a polyimide precursor is dissolved in an organic solvent. Examples of a method of obtaining a porous polyimide film include: a method of obtaining a porous polyimide film by forming pores having a three-dimensionally ordered macroporous structure (3DOM structure) using a silica particle layer as a template; and a method of obtaining a porous polyimide film by preparing a film using a varnish in which silica particles are dispersed in a polyimide precursor solution, firing the film, and removing the silica particles. In the porous polyimide films obtained using these methods, cracking is likely to occur. The reason for this is thought to be that, since the silica particles are not likely to absorb volume shrinkage in an imidization step, strains (residual stress) are likely to be generated in the film.

Further, a method of forming a film using a solution in which a water-soluble resin such as polyethylene glycol is dissolved in a polyimide precursor solution, and bringing the film into contact with a poor solvent such as water to promote deposition of polyimide precursor and formation of pores such that the film is imidized is known. However, in this method, the polyimide precursor is deposited in a porous shape by replacing a solvent such as NMP for dissolving the polyimide precursor with a poor solvent such as water, and it is difficult to control the shape and size of pores.

In addition, for example, a method of preparing a porous polyimide film by obtaining a polyimide-particle composite film using a varnish solution including polyamic acid or polyimide and particles, and then removing the particles from the polyimide-particle composite film may be used. In this method, a solvent including a polar aprotic solvent is used as a solvent in the varnish solution. In a case where the particles are resin particles, the resin particles swell or dissolve in the varnish solution. Therefore, in this method, it is difficult to use resin particles as the particles, and silica particles are used. However, since silica particles are used, residual stress is likely to be generated due to volume shrinkage, and a porous polyimide film obtained using this method is likely to crack, for example.

In contrast, in the polyimide precursor solution according to the exemplary embodiment, and the method of forming a porous polyimide film according to the exemplary embodiment, the polyimide precursor solution including the aqueous solvent, the resin particles which are not dissolved in the aqueous solvent, the organic amine compound, the polyimide precursor, and the water-soluble nonionic surfactant is used in the process of forming the porous polyimide film. Therefore, a film including a polyimide precursor and resin particles may be formed while maintaining the shape of the resin particles. In the step of heating the film for imidization, the resin particles may be removed while maintaining the shape of the resin particles. As a result, the residual stress generated by volume shrinkage is likely to be relaxed. In addition, it appears that since the porous polyimide film obtained in the above-described steps includes the organic amine compound and the nonionic surfactant, the flexibility of the porous polyimide film is likely to increase, thereby preventing cracking.

In addition, in the porous polyimide film obtained in the above-described forming steps, variations in the shape of pores, the pore diameter, and the like are likely to be prevented. The reason for this is thought to be that the use of resin particles in the forming steps effectively contributes to relaxation of residual stress in the step of imidizing the polyimide precursor.

In addition, in the porous polyimide film obtained in the above-described forming steps, the polyimide precursor is dissolved in the aqueous solvent. Therefore, the boiling point of the polyimide precursor solution is about 100° C. While heating the film including the polyimide precursor and the resin particles, the solvent is rapidly volatilized, and then an imidization reaction progresses. Before the resin particles in the film are deformed by heat, the fluidity of the film is lost, and the film is not dissolved in an organic solvent. Therefore, it is thought that the shape of pores is likely to be maintained, and variations in the shape of pores, the pore diameter, and the like are likely to be prevented.

In addition, in the above-described steps of forming a porous polyimide film, the porous polyimide film does not include a polar aprotic solvent. Therefore, the resin particles are not likely to swell or dissolve. As a result, the shape of pores is likely to be maintained in a shape of the resin particles and is likely to be substantially spherical, and thus the pore diameter is likely to be uniform.

In a case where silica particles are used, it is necessary to use a chemical such as hydrofluoric acid in a treatment of removing the silica particles. In a case a template of a silica particle layer is prepared, the silica particle layer is formed. Therefore, the productivity is low, and the costs are high. In addition, in a case where silica particles are used, a chemical such as hydrofluoric acid is used. Therefore, it is thought that ions are likely to remain as impurities.

In addition, according to the method of forming a porous polyimide film according to the exemplary embodiment, silica particles are not used. Therefore, the steps for obtaining the porous polyimide film are simplified. In addition, hydrofluoric acid is not used to remove the resin particles. Therefore, the remaining of ions as impurities is prevented.

Hereinafter, the polyimide precursor solution according to the exemplary embodiment will be described with reference to each step of the method of forming a porous polyimide film according to the exemplary embodiment.

### Method of Forming Porous Polyimide Film

In the porous polyimide film obtained by the method of forming a porous polyimide film according to the exemplary embodiment, specifically, polyimide included in the porous polyimide film is obtained as follows. A polyimide precursor is prepared by polymerizing tetracarboxylic dianhydride and a diamine compound so as to obtain a solution of the polyimide precursor, and the obtained solution is subjected to an imidization reaction, thereby obtaining the polyimide. More specifically, the polyimide is obtained by performing the imidization reaction by using the polyimide precursor solution in which the polyimide precursor and the organic amine compound are dissolved in the aqueous solvent including water. For example, a method of obtaining a polyimide precursor solution by polymerizing tetracarboxylic dianhydride and a diamine compound in an aqueous solvent in the presence of an organic amine compound to prepare a resin (polyimide precursor) may be used. However, the invention is not limited to this example.

Here, the polar aprotic solvent (for example, N-methylpyrrolidone) may be included in the porous polyimide film, but preferably, it is not included. The polar aprotic solvent will be described below.

In this specification, “not including a polar aprotic solvent” denotes that a polar aprotic solvent is not substantially included. That is, the meaning includes not only a case where a polar aprotic solvent is not included (for example, the content of a polar aprotic solvent is a detection limit or lower when measured using an analyzer (for example, a pyrolysis gas chromatograph)) but also a case where the content of a polar aprotic solvent is 0.001% by weight or lower with respect to the total weight of the porous polyimide film.

The method of forming a porous polyimide film according to the exemplary embodiment includes a first step and a second step as follows.

The first step is a step of forming a coated film by applying the polyimide precursor solution including the aqueous solvent, the resin particles, the organic amine compound, the polyimide precursor, and the water-soluble nonionic surfactant, and then drying the coated film so as to form a film including the polyimide precursor and the resin particles.

In the second step, the film is heated to imidize the polyimide precursor such that a polyimide film is formed, in which a treatment of removing the resin particles is included.

Regarding the treatment of removing the resin particles, in a case where the resin particles are removed using an organic solvent for dissolving the resin particles, even when the removability is low in order to crosslink the resin, the resin particles may be removed by heating.

### First Step

In the first step, first, a polyimide precursor solution including an aqueous solvent, resin particles, an organic amine compound, a polyimide precursor, and a water-soluble nonionic surfactant (hereinafter, may be referred to as “resin particle-dispersed polyimide precursor solution”) is prepared.

Regarding the polyimide precursor solution, first, the resin particles, and a polyimide precursor solution obtained by dissolving the polyimide precursor in the aqueous solvent are prepared. Examples of the polyimide precursor solution in which the polyimide precursor is dissolved include a polyimide precursor solution obtained by dissolving a polyimide precursor and an organic amine compound.

Then, a polyimide precursor solution including the resin particles is obtained by mixing the resin particles and the polyimide precursor solution obtained by dissolving the polyimide precursor and the organic amine compound. In addition, by including a water-soluble nonionic surfactant, the polyimide precursor solution (resin particle-dispersed polyimide precursor solution) including the aqueous solvent, the resin particles, the organic amine compound, the polyimide precursor, and the water-soluble nonionic surfactant is obtained.

Next, a coated film is formed by coating the substrate with the obtained resin particle-dispersed polyimide precursor solution. In this coated film, the polyimide precursor solution, the resin particles, and the water-soluble nonionic surfactant are included. Then, the resin particles in the coated film are distributed in a state where the aggregation is prevented. After that, the coated film formed on the substrate is dried, and thereby a film including the polyimide precursor and the resin particles is formed. Note that, the order of adding the water-soluble nonionic surfactant is not particularly limited.

The substrate on which the film including the polyimide precursor and the resin particles is formed is not particularly limited. Examples of the substrate include: a resin substrate such as polystyrene or polyethylene terephthalate; a glass substrate; a ceramic substrate; a metal substrate such as iron or stainless steel (SUS); and a composite material substrate obtained by combining the above-described materials with each other. Optionally a release layer may be provided on the substrate by treating the substrate with, for example, a silicone or fluorine release agent. It is also effective that the surface of the substrate is roughened to have a particle diameter similar to the particle diameter of the resin particles such that the exposure of surfaces of the resin particles contacting the substrate is promoted.

A method of applying the resin particle-dispersed polyimide precursor solution to the substrate is not particularly limited. Examples of the method include various methods such as a spray coating method, a spin coating method, a roll coating method, a bar coating method, a slit die coating method, or an ink jet coating method.

In a case where the resin particle-dispersed polyimide precursor solution is applied to the substrate to forma coated film, the resin particles may be added in an amount in which the resin particles are exposed from the surface of the coated film.

After the coated film including the polyimide precursor solution and the resin particles, which is obtained using the above-described method, is formed, the coated film is dried to form a film including the polyimide precursor and the resin particles. Specifically, the coated film including the polyimide precursor solution and the resin particles is dried using, for example, a method such as heating drying, natural drying, or vacuum drying to form the film. More specifically, the coated film is dried to form the film such that the amount of the solvent remaining in the film is 50% or lower (preferably 30% or lower) with respect to the solid content of the film. This film is in a state where the polyimide precursor is soluble in water.

In addition, after the coated film is obtained in the first step, a treatment of exposing the resin particles is performed in the process of forming the coated film and drying the coated film to form the film such that the resin particles are exposed. By performing the treatment of exposing the resin particles, the area ratio of the pores in the porous polyimide film is increased.

Specific examples of the treatment of exposing the resin particles include the following method.

After the coated film including the polyimide precursor solution and the resin particles is obtained, in the process of drying the coated film to form a film including the polyimide precursor and the resin particles, as described above, the film is in a state where the polyimide precursor is soluble in water. When the film is in this state, for example, the resin particles may be exposed through, for example, a wiping treatment or a treatment of dipping the film in water. Specifically, the polyimide precursor solution present in the resin particle layer is removed by performing the treatment of exposing the resin particle layer through, for example, water wiping. Resin particles present in an upper region of the resin particle layer (that is, a region of the resin particle layer on a side distant from the substrate) are exposed from the surface of the film.

Even in a case where the film is formed on the substrate using the resin particle-dispersed polyimide precursor solution such that the resin particles are embedded in the film, the same treatment as the above-described treatment of exposing the resin particles may be adopted as a treatment of exposing the resin particle embedded in the film.

A method of preparing the resin particle-dispersed polyimide precursor solution is not particularly limited. From the viewpoint of simplifying the steps, the polyimide precursor may be synthesized in an aqueous solvent dispersion in which resin particles, which are insoluble in the polyimide precursor solution, are dispersed in the aqueous solvent in advance. Specifically, the following methods may be exemplified.

In the aqueous solvent including water, a resin particle dispersion is prepared by granulating resin particles. Then, a polyimide precursor solution obtained by polymerizing tetracarboxylic dianhydride and a diamine compound in the resin particle dispersion in the presence of an organic amine compound to prepare a resin (polyimide precursor). Further, a water-soluble nonionic surfactant may be added to the obtained polyimide precursor solution so as to obtain a resin particle-dispersed polyimide precursor solution.

Examples of the method of preparing the resin particle-dispersed polyimide precursor solution further include a method of mixing the polyimide precursor solution with dry resin particles, and a method of mixing the polyimide precursor solution with a dispersion in which the resin particles are dispersed in the aqueous solvent in advance.

As the dispersion in which the resin particles are dispersed in the aqueous solvent in advance, a dispersion in which the resin particles are dispersed in the aqueous solvent in advance may be prepared, or a commercially available dispersion in which the resin particles are dispersed in the aqueous solvent in advance may be used. In a case where the dispersion in which the resin particles are dispersed in advance is prepared, the dispersibility of the resin particles may be improved using at least one of an ionic surfactant or a nonionic surfactant.

In addition, a substrate is coated with the resin particle-dispersed polyimide precursor solution obtained as described above by using the above-described method so as to form a coated film. After that, the coated film is dried, and thereby a film is formed on the substrate.

### Second Step

In the second step, the film including the polyimide precursor and the resin particles, which is obtained in the first step, is heated to imidize the polyimide precursor such that a polyimide film is formed. In the second step, a treatment of removing the resin particles is included. Through the treatment of removing the resin particles, a porous polyimide film is obtained.

In the second step, in the process of forming the polyimide film, specifically, the film including the polyimide precursor and the resin particles, which is obtained in the first step, is heated to promote imidization and is further heated to form the polyimide film. As the imidization progresses and the imidization ratio increases, the film becomes not dissolved in the solvent.

In the second step, the treatment of removing the resin particles is performed. The resin particles may be removed in the process of heating the film to imidize the polyimide precursor, or may be removed from the polyimide film after the completion of the imidization (after imidization).

In the exemplary embodiment, the process of imidizing the polyimide precursor denotes the process before the state where the imidized polyimide film is obtained by heating the film including the polyimide precursor and the resin particles, which is obtained in the first step, to promote the imidization.

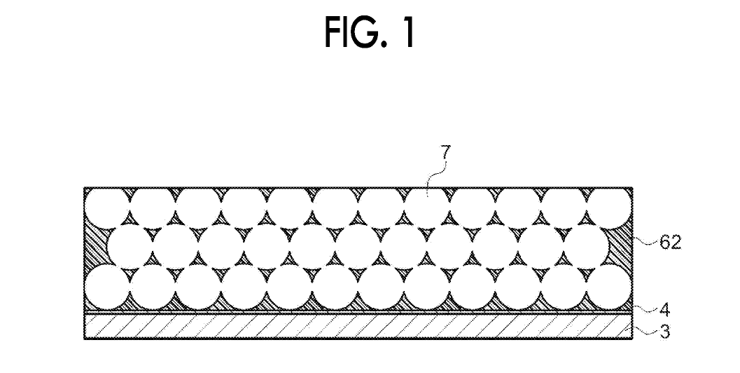

Specifically, the resin particles are removed from the film in the process of imidizing the polyimide precursor (hereinafter, the film in this state may be referred to as “polyimide film”) by heating the coated film obtained in first step. Alternatively, the resin particles may be removed from the polyimide film in which the imidization is finished. Then, the porous polyimide film in which the resin particles are removed may be obtained (refer to FIG. 1).

In FIG. 1, reference numeral 3 represents a substrate, reference numeral 4 represents a release layer, reference numeral 7 represents pores, and reference numeral represents a porous polyimide film.

In the process of removing the resin particles, the porous polyimide film may include the resin component of the resin particles as the resin other than a polyimide resin. Although not shown in the drawing, the porous polyimide film may include the resin other than a polyimide resin.

From the viewpoint of removability for the resin particles, the treatment of removing the resin particles may be performed when the imidization ratio of the polyimide precursor in the polyimide film is 10% or higher in the process of imidizing the polyimide precursor. When the imidization ratio is 10% or higher, the polyimide film is not likely to be dissolved in the solvent, and the form thereof is likely to be maintained.

The treatment of removing the resin particles is not particularly limited as long as it is possible to obtain the porous polyimide film. For example, a method of decomposing and removing resin particles by heating, a method of removing the resin particles by an organic solvent that dissolves the resin particles, or a method of removing the resin particles by decomposition with a laser or the like may be exemplified.

The resin particles may be removed by performing only the method of decomposing and removing the resin particles by heating, or may be removed by performing both the method of decomposing and removing the resin particles by heating and the method of removing the resin particles using an organic solvent for dissolving the resin particles in combination. From the viewpoint of promoting the relaxation of residual stress and preventing cracking of the porous polyimide film, the method which includes the treatment of removing the resin particles using an organic solvent for dissolving the resin particles may be used. The reason for this effect is thought to be that, in the treatment of removing the resin particles using an organic solvent, the resin component dissolved in the organic solvent easily move into the polyimide resin.

For example, in the method of heating the resin particles to be removed, cracked gas may be produced due to heating depending on the kind of the resin particles. Due to this cracked gas, for example, the porous polyimide film may fracture or crack. Therefore, from the viewpoint of preventing cracking, the method of removing the resin particles using an organic solvent for dissolving the resin particles may be adopted.

After removing the resin particles using an organic solvent for dissolving the resin particles, it is also effective to further perform the heating method to improve the removal rate.

In a case where the resin particles are removed using the method of removing the resin particles using an organic solvent for dissolving the resin particles, the resin component of the resin particles dissolved in the organic solvent may infiltrate into the polyimide film in the process of removing the resin particles. Therefore, by adopting this method, the obtained porous polyimide film may actively include the resin other than a polyimide resin. From the viewpoint of including the resin other than a polyimide resin, the method of removing the resin particles using an organic solvent for dissolving the resin particles may be adopted. Further, from the viewpoint of including the resin other than a polyimide resin, the method of removing the resin particles using an organic solvent for dissolving the resin particles may be performed on the film in the process of imidizing the polyimide precursor (polyimide film). By dissolving the resin particles in the form of the polyimide film in the solvent for dissolving the resin particles, the resin particles are more likely to infiltrate into the polyimide film.

Examples of the method of removing the resin particles using an organic solvent for dissolving the resin particles include a method of bringing the resin particles into contact with an organic solvent for dissolving the resin particles (for example, dipping the resin particles in the solvent, bringing the resin particles into contact with solvent vapor) to dissolve the resin particle therein. The resin particles may be dipped in the solvent in the above-described state from the viewpoint of increasing the dissolution efficiency of the resin particles.

The organic solvent for dissolving the resin particles to be removed is not particularly limited as long as the polyimide film and the imidized polyimide film are insoluble therein and the resin particles are soluble therein. Examples of the organic solvent include: ethers such as tetrahydrofuran or 1,4-dioxane; aromatic solvents such as benzene or toluene; ketones such as acetone; and esters such as ethyl acetate.

Among these, ethers such as tetrahydrofuran or 1,4-dioxane or aromatic solvents such as benzene or toluene are preferable, and tetrahydrofuran or toluene is more preferable.

In a case where an aqueous solvent remains during the dissolution of the resin particles, the aqueous solvent is dissolved in the solvent for dissolving the non-crosslinked resin particles and the polyimide precursor is deposited such that the film is in a state similar to that in a so-called wet phase inversion method. As a result, it may be difficult to control the pore diameter. Therefore, the resin particles may be removed by being dissolved in the organic solvent after reducing the amount of the remaining aqueous solvent to be 20% by weight or lower and preferably 10% by weight or lower with respect to the weight of the polyimide precursor.

In the second step, a heating method of heating the film obtained in the first step to promote imidization such that a polyimide film is obtained is not particularly limited. Examples of the method include a method of heating the film in multiple stages of two or more stages. For example, in a case where the film is heated in two stages, a specific example of heating conditions is as follows.

Regarding heating conditions of the first stage, the temperature may be a temperature at which the shape of the resin particles is maintained. Specifically, the temperature is, for example, in a range from 50° C. to 150° C. and preferably in a range from 60° C. to 140° C. In addition, the heating time may be in a range from 10 minutes to 60 minutes. As the heating temperature increases, the heating temperature may decrease.

Regarding heating conditions of the second stage, for example, heating is performed at 150° C. to 400° C. (preferably 200° C. to 390° C.) for 20 minutes to 120 minutes. By setting the heating conditions to be in the above-described ranges, the imidization reaction further progresses, and a polyimide film may be formed. During the heating reaction, the temperature may be increased stepwise or is increased slowly at a fixed rate before reaching a final heating temperature.

The heating conditions are not limited to the above-described conditions of the two-step heating method. For example, a one-step heating method may be adopted. In the case of the one-step heating method, for example, the imidization may be completed under only the heating conditions shown in the second stage.

In a case where the treatment of exposing the resin particles is not performed in the first step, from the viewpoint of increasing the area ratio of the pores, the treatment for exposing the resin particles may be performed in the second step to expose the resin particles. In the second step, the treatment of exposing the resin particles may be performed in the process of imidizing the polyimide precursor or after imidization and before the treatment of removing the resin particles.

The treatment of exposing the resin particles is performed, for example, in a case where the polyimide film is in the following state.

In a case where the treatment of exposing the resin particles is performed when the imidization ratio of the polyimide precursor in the polyimide film is lower than 10% (that is, a state where the polyimide film is soluble in water), for example, a wiping treatment or a treatment of dipping the film in water may be used as the treatment of exposing the resin particles embedded in the polyimide film.

In addition, in a case where the treatment of exposing the resin particles is performed when the imidization ratio of the polyimide precursor in the polyimide film is 10% or higher (that is, a state where the polyimide film is not likely to be dissolved in an organic solvent) and when the imidization of the polyimide film is completed, for example, a method of exposing the resin particles by mechanically cutting the film using a tool such as sand paper, a method of etching the polyimide resin with an alkaline solution or the like, or a method of exposing the resin particles by decomposing the film using a laser or the like may be exemplified.

For example, in a case where the mechanical cutting method is used, some of resin particles which are present in an upper region of the resin particle layer (that is, a region of the resin particle layer on a side distant from the substrate) embedded in the polyimide film are cut together with the polyimide film present above the resin particles, and the cut resin particles are exposed from the surface of the polyimide film.

Next, the resin particles are removed from the polyimide film, from which the resin particles are exposed, through the above-described treatment of removing the resin particles. The porous polyimide film from which the resin particles are removed is obtained.

In a case where the film is formed on the substrate using the resin particle-dispersed polyimide precursor solution, the resin particle-dispersed polyimide precursor solution is applied to the substrate to form a coated film in which the resin particles are embedded. Next, in the process of drying the coated film to forma film, in a case where a film including the polyimide precursor and the resin particles is formed without performing the treatment of exposing the resin particles, a film in which the resin particles are embedded may be formed. For example, in a case where the film in which the resin particles are embedded is heated, the film in the process of imidization (the polyimide film) is in a state where the resin particle layer is embedded. As the treatment of exposing the resin particles which is performed in the second step in order to increase the area ratio of the pores, the same treatment as the above-described treatment of exposing the resin particles may be adopted. The polyimide film present above the resin particles is also cut, and the resin particles are exposed from the surface of the polyimide film.

Next, the resin particles are removed from the polyimide film, from which the resin particles are exposed, through the above-described treatment of removing the resin particles. The porous polyimide film from which the resin particles are removed is obtained.

In the second step, the substrate which is used in the first step to form the above-described film may be peeled off from the film when the film is dried, when the polyimide precursor in the polyimide film is not likely to be dissolved in an organic solvent, or when the imidization of the film is completed.

Through the above-described steps, the porous polyimide film including the polyimide resin and the resin other than a polyimide resin is obtained. The porous polyimide film may be post-treated depending on the intended use.

Here, the imidization ratio of the polyimide precursor will be described.

Examples of a partially imidized polyimide precursor include precursors having repeating units represented by formulae (I-1), (I-2), and (I-3).

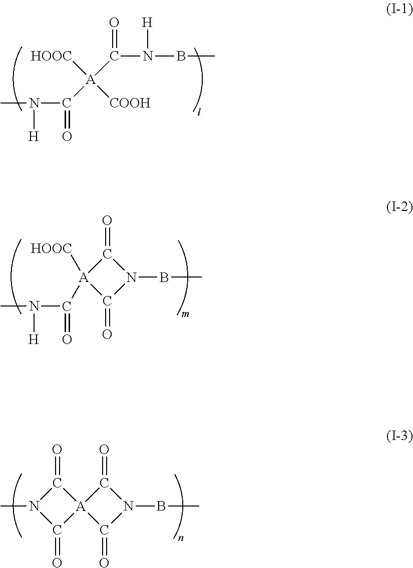

In formulae (I-1), (I-2), and (I-3), A represents a tetravalent organic group, and B represents a divalent organic group. I represents an integer of 1 or more, and m and n each independently represent an integer of 0 or 1 or more.

A and B have the same definitions as those of A and B in formula (I) described below.

The imidization ratio of the polyimide precursor denotes a ratio of the number (2n+m) of binding sites of the polyimide precursor (reaction sites between tetracarboxylic dianhydride and the diamine compound) where an imide ring is closed to the total number (2l+2m+2n) of binding sites of the polyimide precursor. That is, the imidization ratio of the polyimide precursor is represented by “(2n+m)/(2l+2m+2n)”.

The imidization ratio (the value of “(2n+m)/(2l+2m+2n)”) of the polyimide precursor is measured using the following method.

### Measurement of Imidization Ratio of Polyimide Precursor Preparation of Polyimide Precursor Sample

(i) A polyimide precursor solution as a measurement target is applied to a silicon wafer in a thickness range from 1 μm to 10 μm to prepare a coated film sample.

(ii) The coated film sample is dipped in tetrahydrofuran (THF) for 20 minutes such that a solvent in the coated film sample is replaced with tetrahydrofuran (THF). The solvent for dipping is not limited to THF and may be selected from solvents in which the polyimide precursor is insoluble and which may be mixed with the solvent component included in the polyimide precursor solution. Specifically, an alcohol solvent such as methanol or ethanol, or an ether compound such as dioxane may be used.

(iii) The coated film sample is taken out from THF, and N₂ gas is blown to THF attached to the surface of the coated film sample to remove THF from the coated film sample. The coated film sample is dried under reduced pressure of 10 mmHg or lower in a range from 5° C. to 25° C. for 12 hours or longer to prepare a polyimide precursor sample.

Preparation of 100% Imidized Reference Sample

(iv) Using the same method as in (i) described above, a polyimide precursor solution as a measurement target is applied to a silicon wafer to prepare a coated film sample.

(v) The coated film sample is heated at 380° C. for 60 minutes to perform an imidization reaction. As a result, a 100% imidized reference sample is prepared.

### Measurement and Analysis

(vi) Using a Fourier transform infrared spectrometer (FT-730, manufactured by Horiba Ltd.), infrared absorption spectra of the 100% imidized reference sample and the polyimide precursor sample are measured. In the 100% imidized reference sample, a ratio I′ (100) of an imide bond-derived absorption peak (Ab′ (1780 cm⁻¹)) present near 1780 cm⁻¹ to an aromatic ring-derived absorption peak (Ab′ (1500 cm⁻¹)) present near 1500 cm⁻¹ is obtained.

(vii) By performing the same measurement on the polyimide precursor sample, a ratio I(x) of an imide bond-derived absorption peak (Ab(1780 cm⁻¹)) present near 1780 cm⁻¹ to an aromatic ring-derived absorption peak (Ab(1500 cm⁻¹)) present near 1500 cm⁻¹ is obtained.

Using the respective measured absorption peaks I′ (100) and I(x), the imidization ratio of the polyimide precursor is calculated based on the following expressions.

Imidization Ratio of Polyimide Precursor=I(x)/I′(100)

I(100)=(Ab′(1780 cm⁻¹))/(Ab′(1500 cm⁻¹))

I′(x)=(Ab(1780 cm⁻¹))/(Ab(1500 cm⁻¹))

This measurement of the imidization ratio of the polyimide precursor may be adopted for the measurement of the imidization ratio of an aromatic polyimide precursor. In a case where the imidization ratio of an aromatic polyimide precursor is measured, a peak derived from a structure having no change before and after the imidization reaction is used as an internal standard peak instead of the aromatic ring-derived absorption peak.

Next, the compounds of the polyimide precursor solution according to the exemplary embodiment will be described.

### Polyimide Precursor Solution

The polyimide precursor solution includes an aqueous solvent, resin particles, an organic amine compound, a polyimide precursor, and a water-soluble nonionic surfactant.

Hereinafter, the components of the polyimide precursor solution will be described.

### Polyimide Precursor

The polyimide precursor is a resin (polyimide precursor) having repeating units represented by formula (I).

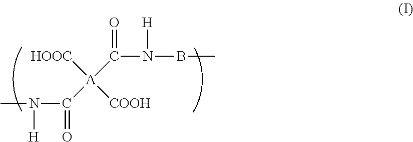

In formula (I), A represents a tetravalent organic group, and B represents a divalent organic group.

Here, in formula (I), the tetravalent organic group represented by A is a residue obtained by removing four carboxyl groups from tetracarboxylic dianhydride as a raw material.

On the other hand, the divalent organic group represented by B is a residue obtained by removing two amino groups from the diamine compound as a raw material.

That is, the polyimide precursor having a repeating unit represented by formula (I) is a polymer obtained by polymerization of tetracarboxylic dianhydride and the diamine compound.

Examples of the tetracarboxylic dianhydride include an aromatic compound and an aliphatic compound. Among these, an aromatic compound is preferable. That is, it is preferable that the tetravalent organic group represented by A in formula (I) is an aromatic organic group.

Examples of the aromatic tetracarboxylic dianhydride include pyromellitic dianhydride, 3,3′,4,4′-benzophenone tetracarboxylic dianhydride, 3,3′,4,4′-biphenyl sulfone tetracarboxylic dianhydride, 1,4,5,8-naphthalene tetracarboxylic dianhydride, 2,3,6,7-naphthalene tetracarboxylic dianhydride, 3,3′,4,4′-biphenyl ether tetracarboxylic dianhydride, 3,3′,4,4′-dimethyldiphenyl silane tetracarboxylic dianhydride, 3,3′,4,4′-tetraphenyl silane tetracarboxylic dianhydride, 1,2,3,4-furan tetracarboxylic dianhydride, 4,4′-bis(3,4-dicarboxyphenoxy)diphenylsulfide dianhydride, 4,4′-bis (3,4-dicarboxyphenoxy)diphenyl sulfone dianhydride, 4,4′-bis (3,4-dicarboxyphenoxy)diphenyl propane dianhydride, 3,3′,4,4′-perfluoroisopropylidene diphthalic dianhydride, 3,3′,4,4′-biphenyl tetracarboxylic dianhydride, 2,3,3′,4′-biphenyl tetracarboxylic dianhydride, bis(phthalic acid) phenylphosphine oxide dianhydride, p-phenylene-bis(triphenylphthalic acid) dianhydride, m-phenylene-bis(triphenylphthalic acid) dianhydride, bis(triphenylphthalic acid)-4,4′-diphenyl ether dianhydride, and bis(triphenylphthalic acid)-4,4′-diphenylmethane dianhydride.

Examples of the aliphatic tetracarboxylic dianhydride include an aliphatic or alicyclic tetracarboxylic dianhydride such as butane tetracarboxylic dianhydride, 1,2,3,4-cyclobutane tetracarboxylic dianhydride, 1,3-dimethyl-1,2,3,4-cyclobutanetetracarboxylic dianhydride, 1,2,3,4-cyclopentane tetracarboxylic dianhydride, 2,3,5-tricarboxycyclopentyl acetic dianhydride, 3,5,6-tricarboxynorbornane-2-acetic dianhydride, 2,3,4,5-tetrahydrofuran tetracarboxylic dianhydride, 5-(2,5-dioxotetrahydrofuryl)-3-methyl-3-cyclohexene-1,2-di carboxylic dianhydride, or bicyclo[2,2,2]-oct-7-ene-2,3,5,6-tetracarboxylic dianhydride; and an aliphatic tetracarboxylic dianhydride having an aromatic ring such as 1,3,3a,4,5,9b-(hexahydro-2,5-dioxo-3-furanyl)-naphtho[1,2-c]furan-1,3-dione, 1,3,3a,4,5,9b-hexahydro-5-methyl-5-(tetrahydro-2,5-dioxo-3-furanyl)-naphtho-[1,2-c]furan-1,3-dione, or 1,3,3a,4,5,9b-hexahydro-8-methyl-5-(tetrahydro-2,5-dioxo-3-furanyl)-naphtho[1,2-c]furan-1,3-dione.

Among these, as the tetracarboxylic dianhydride, an aromatic tetracarboxylic dianhydride is preferable.

Specifically, for example, pyromellitic dianhydride, 3,3′,4,4′-biphenyl tetracarboxylic dianhydride, 2,3,3′,4′-biphenyl tetracarboxylic dianhydride, 3,3′,4,4′-biphenyl ether tetracarboxylic dianhydride, or 3,3′,4,4′-benzophenone tetracarboxylic dianhydride is preferable, pyromellitic dianhydride, 3,3′,4,4′-biphenyl tetracarboxylic dianhydride, or 3,3′,4,4′-benzophenone tetracarboxylic dianhydride is more preferable, and 3,3′,4,4′-biphenyl tetracarboxylic dianhydride is still more preferable.

Among these tetracarboxylic dianhydrides, one kind may be used alone, or two or more kinds may be used in combination.

In a case where two or more tetracarboxylic dianhydrides are used in combination, a combination of aromatic tetracarboxylic dianhydrides, a combination of aliphatic tetracarboxylic dianhydrides, or a combination of an aromatic tetracarboxylic dianhydride and an aliphatic tetracarboxylic dianhydride may be used.

On the other hand, the diamine compound is a diamine compound having two amino groups in a molecular structure thereof. Examples of the diamine compound include an aromatic compound and an aliphatic compound. Among these, an aromatic compound is preferable. That is, it is preferable that the divalent organic group represented by B in formula (I) is an aromatic organic group.

Examples of the diamine compound include: an aromatic diamine such as p-phenylenediamine, m-phenylenediamine, 4,4′-diaminodiphenylmethane, 4,4′-diaminodiphenylethane, 4,4′-diaminodiphenylether, 4,4′-diaminodiphenylsulfide, 4,4′-diaminodiphenylsulfone, 1,5-diaminonaphthalene, 3,3-dimethyl-4,4′-diaminobiphenyl, 5-amino-1-(4′-aminophenyl)-1,3,3-trimethylindane, 6-amino-1-(4′-aminophenyl)-1,3,3-trimethylindane, 4,4′-diaminobenzanilide, 3,5-diamino-3′-trifluoromethylbenzanilide, 3,5-diamino-4′-trifluoromethylbenzanilide, 3,4′-diaminodiphenylether, 2,7-diaminofluorene, 2,2-bis(4-aminophenyl)hexafluoropropane, 4,4′-methylene-bis(2-chloroaniline), 2,2′,5,5′-tetrachloro-4,4′-diaminobiphenyl, 2,2′-dichloro-4,4′-diamino-5,5′-dimethoxybiphenyl, 3,3′-dimethoxy-4,4′-diaminobiphenyl, 4,4′-diamino-2,2′-bis(trifluoromethyl)biphenyl, 2,2-bis[4-(4-aminophenoxy)phenyl]propane, 2,2-bis[4-(4-aminophenoxy)phenyl]hexafluoropropane, 1,4-bis(4-aminophenoxy)benzene, 4,4′-bis(4-aminophenoxy)-biphenyl, 1,3′-bis(4-aminophenoxy)benzene, 9,9-bis(4-aminophenyl)fluorene, 4,4′-(p-phenyleneisopropylidene)bisaniline, 4,4′-(m-phenyleneisopropylidene)bisaniline, 2,2′-bis[4-(4-amino-2-trifluoromethylphenoxy)phenyl]hexafluoropropane, or 4,4′-bis[4-(4-amino-2-trifluoromethyl)phenoxy]-octafluorobiphenyl; an aromatic diamine having two amino groups bonded to an aromatic ring and hetero atoms other than nitrogen atoms of the amino groups, such as diaminotetraphenyl thiophene; and an aliphatic or alicyclic diamine such as 1,1-metaxylylenediamine, 1,3-propanediamine, tetramethylenediamine, pentamethylenediamine, octamethylenediamine, nonamethylenediamine, 4,4-diaminoheptamethylenediamine, 1,4-diaminocyclohexane, isophoronediamine, tetrahydrodicyclopentadienylenediamine, hexahydro-4,7-methanoindanylene dimethylenediamine, tricyclo[6,2,1,0^{2.7}]-undecylene dimethyldiamine, or 4,4′-methylenebis(cyclohexylamine).

Among these, as the diamine compound, an aromatic diamine compound is preferable. Specifically, for example, p-phenylenediamine, m-phenylenediamine, 4,4′-diaminodiphenylmethane, 4,4′-diaminodiphenylether, 3,4′-diaminodiphenylether, 4,4′-diaminodiphenylsulfide, or 4,4′-diaminodiphenylsulfone is preferable, and 4,4′-diaminodiphenylether or p-phenylenediamine is more preferable.

Among these diamine compounds, one kind may be used alone, or two or more kinds may be used in combination. In addition, in a case where two or more diamine compounds are used in combination, a combination of aromatic diamine compounds, a combination of aliphatic diamine compounds, or a combination of an aromatic diamine compound and an aliphatic diamine compound may be used.

The number average molecular weight of the polyimide precursor is preferably from 1,000 to 150,000, more preferably from 5,000 to 130,000, and still more preferably from 10,000 to 100,000.

In a case where the number average molecular weight of the polyimide precursor is in the above-described range, deterioration in the solubility of the polyimide precursor in a solvent is prevented, and film forming properties are easily ensured.

The number average molecular weight of the polyimide precursor is measured using gel permeation chromatography (GPC) under the following measurement conditions.

Column: Tosoh TSKgel α-M (7.8 mm, I.D.×30 cm)

Eluent: dimethylformamide (DMF)/30 mM LiBr/60 mM phosphoric acid

Flow rate: 0.6 mL/min

Injection amount: 60 μL

Detector: a differential refractometer (RI)

The content (concentration) of the polyimide precursor is from 0.1% by weight to 40% by weight, preferably from 0.5% by weight to 25% by weight, and more preferably from 1% by weight to 20% by weight with respect to the total weight of the polyimide precursor solution.

### Organic Amine Compound

The organic amine compound is a compound which forms an amine salt with the polyimide precursor (a carboxyl group thereof) to improve the solubility in the aqueous solvent thereof and which also functions as an imidization promoter. Specifically, the organic amine compound may be an amine compound having a molecular weight of 170 or lower. The organic amine compound may be a compound other than the diamine compound which is the raw material of the polyimide precursor.

The organic amine compound may be a water-soluble compound. “Water-soluble” denotes that 1% by weight or higher of a target material is soluble in water at 25° C.

Examples of the organic amine compound include a primary amine compound, a secondary amine compound, and a tertiary amine compound.

Among these, as the organic amine compound, at least one (in particular, a tertiary amine compound) selected from the group consisting of a secondary amine compound and a tertiary amine compound is preferable. In a case where a tertiary amine compound or a secondary amine compound (in particular, a tertiary amine compound) is used as the organic amine compound, the solubility of the polyimide precursor in the solvent is likely to increase, film forming properties are likely to be improved, and the storage stability of the polyimide precursor solution is likely to be improved.

In addition, examples of the organic amine compound include a monovalent amine compound and a divalent or higher polyvalent amine compound. In a case where a divalent or higher polyvalent amine compound is used, a pseudo-crosslinked structure is likely to be formed between molecules of the polyimide precursor, and the storage stability of the polyimide precursor solution is likely to be improved.

Examples of the primary amine compound include methylamine, ethylamine, n-propylamine, isopropylamine, 2-ethanolamine, and 2-amino-2-methyl-1-propanol.

Examples of the secondary amine compound include dimethylamine, 2-(methylamino)ethanol, 2-(ethylamino)ethanol, and morpholine.

Examples of the tertiary amine compound include 2-dimethylaminoethanol, 2-diethylaminoethanol, 2-dimethylaminopropanol, pyridine, triethylamine, picoline, N-methylmorpholine, N-ethylmorpholine, 1,2-dimethylimidazole, 2-ethyl-4-methylimidazole, N-methylpiperidine, and N-ethylpiperidine.

From the viewpoints of the pot life of the polyimide precursor solution and the film thickness uniformity, a tertiary amine compound may be used. From these viewpoints, the organic amine compound may be at least one kind selected from the group consisting of 2-dimethylaminoethanol, 2-diethylaminoethanol, 2-dimethylaminopropanol, pyridine, triethylamine, picoline, N-methylmorpholine,

N-ethylmorpholine, 1,2-dimethylimidazole, 2-ethyl-4-methylimidazole, N-methylpiperidine, and N-ethylpiperidine.

Here, from the viewpoint of film forming properties, the organic amine compound may be an amine compound which has an aliphatic cyclic structure or an aromatic cyclic structure having a nitrogen-containing heterocyclic structure (hereinafter, referred to as “nitrogen-containing heterocyclic amine compound”). It is more preferable that the nitrogen-containing heterocyclic amine compound is a tertiary amine compound.

Examples of the nitrogen-containing heterocyclic amine compound include isoquinolines (amine compounds having an isoquinoline skeleton), pyridines (amine compounds having a pyridine skeleton), piperidines (amine compounds having a piperidine skeleton), pyrimidines (amine compounds having a pyrimidine skeleton), pyrazines (amine compounds having a pyrazine skeleton), piperazines (amine compounds having a piperazine skeleton), triazines (amine compounds having a triazine skeleton), imidazoles (amine compounds having an imidazole skeleton), morpholines (amine compounds having a morpholine skeleton), polyaniline, polypyridine, and polyamine.

From the viewpoint of film forming properties, the nitrogen-containing heterocyclic amine compound is preferably at least one kind selected from the group consisting of morpholines, pyridines, piperidines, and imidazoles, and is more preferably morpholines (an amine compound having a morpholine skeleton). Among them, at least one kind selected from the group consisting of N-methylmorpholine, N-methylpiperidine, pyridine, 1,2-dimethylimidazole, 2-ethyl-4-methylimidazole, and picoline is more preferable, and N-methylmorpholine is still more preferable.

Among these, it is preferable that the organic amine compound is a compound having a boiling point of 60° C. or higher (preferably from 60° C. to 200° C., and more preferably from 70° C. to 150° C.). In a case where the boiling point of the organic amine compound is 60° C. or higher, the volatilization of the organic amine compound from the polyimide precursor solution is prevented during storage, and deterioration in the solubility of the polyimide precursor in the solvent is likely to be prevented.

The content of the organic amine compound is from 50% by mol to 500% by mol, preferably from 80% by mol to 250% by mol, and more preferably from 90% by mol to 200% by mol with respect to the amount of carboxyl groups (—COOH) of the polyimide precursor in the polyimide precursor solution.

In a case where the content of the organic amine compound is in the above-described range, the solubility of the polyimide precursor in the solvent is likely to increase, and film forming properties are likely to be improved. In addition, the storage stability of the polyimide precursor solution is likely to be improved.

Among these organic amine compounds, one kind may be used alone, or two or more kinds may be used in combination.

Aqueous Solvent including Water

Specifically, the aqueous solvent including water is preferably a solvent including 50% by weight or more of water with respect to the total aqueous solvent. Examples of water include distilled water, ion-exchange water, ultrafiltered water, and pure water.

The content of the water is preferably from 50% by weight to 100% by weight, more preferably from 70% by weight to 100% by weight, and still more preferably from 80% by weight to 100% by weight with respect to the total weight of the aqueous solvent.

In a case where the aqueous solvent includes a solvent other than water, examples of the solvent other than water include a water-soluble organic solvent. As the solvent other than water, a water-soluble organic solvent is preferable from the viewpoints of the transparency, mechanical strength, and the like of a polyimide molded article. Here, “water-soluble” denotes that 1% by weight or higher of a target material is dissolved in water at 25° C.

Among these water-soluble organic solvents, one kind may be used alone, or two or more kinds may be used in combination.

A water-soluble ether solvent is a water-soluble solvent having an ether bond in one molecule. Examples of the water-soluble ether solvent include tetrahydrofuran (THF), dioxane, trioxane, 1,2-dimethoxyethane, diethylene glycol dimethyl ether, and diethylene glycol diethyl ether. Among these, tetrahydrofuran or dioxane is preferable as the water-soluble ether solvent.

A water-soluble ketone solvent is a water-soluble solvent having a ketone group in one molecule. Examples of the water-soluble ketone solvent include acetone, methyl ethyl ketone, and cyclohexanone. Among these, acetone is preferable as the water-soluble ketone solvent.

A water-soluble alcohol solvent is a water-soluble solvent having an alcoholic hydroxyl group in one molecule. Examples of the water-soluble alcohol solvent include methanol, ethanol, 1-propanol, 2-propanol, tert-butyl alcohol, ethylene glycol, ethylene glycol monoalkyl ether, propylene glycol, propylene glycol monoalkyl ether, diethylene glycol, diethylene glycol monoalkyl ether, 1,2-propanediol, 1,3-propanediol, 1,3-butanediol, 1,4-butanediol, 2,3-butanediol, 1,5-pentanediol, 2-buten-1,4-diol, 2-methyl-2,4-pentanediol, glycerin, 2-ethyl-2-hydroxymethyl-1,3-propanediol, and 1,2,6-hexanetriol. Among these, as the water-soluble alcohol solvent, methanol, ethanol, 2-propanol, ethylene glycol, ethylene glycol monoalkyl ether, propylene glycol, propylene glycol monoalkyl ether, diethylene glycol, or diethylene glycol monoalkyl ether is preferable.

Specific examples of the polar aprotic solvent include N-methyl-2-pyrrolidone (NMP), N,N-dimethylformamide (DMF), N,N-dimethylacetamide (DMAc), N,N-diethylacetamide (DEAc), dimethylsulfoxide (DMSO), hexamethylphosphoramide (HMPA), N-methylcaprolactam, N-acetyl-2-pyrrolidone, N,N-dimethylimidazolidinone (DMI), and 1,3-dimethyl-imidazolidone. In a case of using the polar aprotic solvent, the porous polyimide film may not include the polar aprotic solvent.

In a case where the aqueous solvent includes a solvent other than water, the boiling point of the solvent to be used in combination is 270° C. or lower, preferably from 60° C. to 250° C., and more preferably from 80° C. to 230° C. In a case where the boiling point of the solvent to be used in combination is in the above-described range, the solvent other than water is not likely to remain in a polyimide molded article, and the mechanical strength of the obtained polyimide molded article is likely to be high.

Here, the solubility of the polyimide precursor in the solvent is controlled based on the content of water, and the kind and amount of the organic amine compound. In a case where the content of water is low, the polyimide precursor is likely to be dissolved in a region where the content of the organic amine compound is low. On the other hand, in a case where the content of water is high, the polyimide precursor is likely to be dissolved in a region where the content of the organic amine compound is high. In a case where the organic amine compound is highly hydrophilic, for example, has a hydroxyl group, the polyimide precursor is likely to be dissolved in a region where the content of water is high.

In order to prepare the polyimide precursor, a polyimide precursor which is synthesized using an organic solvent such as a polar aprotic solvent (for example, N-methylpyrrolidone (NMP)) may be added to a poor solvent such as water or alcohol, deposited, and separated.

### Resin Particles

The resin particles are not dissolved in the aqueous solvent including water. In addition, the resin particles are not dissolved in the polyimide precursor solution.

The resin particles are not particularly limited, and are formed of resins other than polyimide. Examples of the resin particles include resin particles obtained by polymerization of polymerizable monomers such as a polyester resin or a urethane resin, and resin particles obtained by radical polymerization of polymerizable monomers such as a vinyl resin or an olefin resin. Examples of the resin particles obtained by radical polymerization include resin particles of a (meth)acrylic resin, a (meth)acrylate resin, a styrene-(meth)acrylate resin, a polystyrene resin, a polyethylene resin, and the like.

From the viewpoint of removing the resin particles in the second step described below, the resin particles may be soluble in a solvent in which a polyimide resin is not dissolved.

Further, among them, from the viewpoints of the control of the shape of particles and removability, the resin particles may be formed of a resin obtained using radically polymerizable monomers, and it is preferable that the resin particles are formed of at least one kind selected from the group consisting of a (meth)acrylic resin, a (meth)acrylate resin, a styrene-(meth)acrylate resin, and a polystyrene resin.

Here, the meaning of “not dissolved” includes not only a case where substances as a target are not dissolved in the liquid as a target at 25° C., and but also a case where substances as a target are dissolved in the liquid as a target within a range of 3% by weight or lower.

For example, “not dissolved in the aqueous solvent including water” denotes that the resin particles as a target are not substantially dissolved in the aqueous solvent including water at 25° C., and the meaning thereof includes not only a case where the resin particles are not dissolved in the aqueous solvent including water but also the resin particles are dissolved in the aqueous solvent including water within a range of 3% by weight or lower. In addition, “not dissolved in the polyimide precursor solution” denotes that the resin particles as a target are not substantially dissolved in the polyimide precursor solution at 25° C., and the meaning thereof includes not only a case where the resin particles are not dissolved in the polyimide precursor solution but also the resin particles are dissolved in the polyimide precursor solution within a range of 3% by weight or lower.

Here, “soluble in the organic solvent” denotes that the resin particles as a target are dissolved in the organic solvent as a target at 25° C. in an amount of 10% by weight or higher.

In this specification, “(meth)acryl” represents both “acryl” and “methacryl”.

For example, in a case where the resin particles are vinyl resin particles, a synthesis method thereof is not particularly limited, and a well-known polymerization method (a radical polymerization method such as emulsion polymerization, soap-free emulsion polymerization, suspension polymerization, miniemulsion polymerization, microemulsion polymerization) may be used.

For example, in a case where an emulsion polymerization method is used to prepare vinyl resin particles, the vinyl resin particles are obtained by adding monomers such as a styrene or a (meth)acrylic acid to water, in which a water-soluble polymerization initiator such as potassium persulfate or ammonium persulfate is dissolved, optionally adding a surfactant such as sodium dodecyl sulfate or a diphenyl oxide disulfonate, and heating the components while stirring them.

Examples of a monomer of the vinyl resin include a vinyl resin unit obtained by polymerization of the following monomers including: styrenes having a styrene skeleton such as styrene, an alkyl-substituted styrene (for example, a-methylstyrene, 2-methylstyrene, 3-methylstyrene, 4-methylstyrene, 2-ethylstyrene, 3-ethylstyrene, or 4-ethylstyrene), a halogen-substituted styrene (for example, 2-chlorostyrene, 3-chlorostyrene, or 4-chlorostyrene), or vinylnaphthalene; esters having a vinyl group such as methyl (meth)acrylate, ethyl (meth)acrylate, n-propyl (meth)acrylate, n-butyl (meth)acrylate, lauryl (meth)acrylate, or 2-ethylhexyl (meth)acrylate; vinyl nitriles such as acrylonitrile or methacrylonitrile; vinyl ethers such as vinyl methyl ether or vinyl isobutyl ether; vinyl ketones such as vinyl methyl ketone, vinyl ethyl ketone or vinyl isopropenyl ketone; acids such as (meth)acrylic acid, maleic acid, cinnamic acid, fumaric acid, or vinylsulfonic acid; and bases such as ethyleneimine, vinylpyridine, or vinylamine.

Examples of other monomers which may be used in combination include: monofunctional monomers such as vinyl acetate; bifunctional monomers such as ethylene glycol dimethacrylate, nonane diacrylate, or decanediol diacrylate; and polyfunctional monomers such as trimethylolpropane triacrylate or trimethylolpropane trimethacrylate.

The vinyl resin may be a resin which is obtained using one monomer among the above-described monomers, or may be a copolymer which is obtained using two or more monomers among the above-described monomers.

In a case where the monomers used in the resin constituting the vinyl resin particles include styrene, a ratio of the styrene to all the monomer components is preferably from 20% by weight to 100% by weight and more preferably from 40% by weight to 100% by weight.

The average particle diameter of the resin particles is not particularly limited. For example, it may be in a range from 0.1 μm to 0.5 μm, is preferably in a range from 0.25 μm to 0.5 μm, and is more preferably in a range from 0.25 μm to 0.4 μm. When the average particle diameter of the resin particles is within the above range, the productivity of the resin particles is improved, and the cohesiveness is likely to be prevented.

In order to obtain the average particle diameter of the resin particles, using a particle diameter distribution which is obtained from measurement of a laser diffraction particle diameter distribution analyzer (for example, COULTER COUNTER LS 13 (manufactured by Beckman Coulter Inc.)), a volume cumulative distribution is drawn on divided particle diameter ranges (channels) in order from the smallest particle diameter. A particle diameter having a cumulative value of 50% with respect to all the particles is defined as a volume average particle diameter D50v.

As the resin particles of the resin other than a polyimide resin that is soluble in a solvent in which a polyimide resin is insoluble, for example, non-crosslinked resin particles having a non-crosslinked structure may be used. However, the resin particles may be crosslinked within a range where the above-described solubility is satisfied. Specific examples of the resin particles include polymethyl methacrylate (MB series, manufactured by Sekisui Plastics Co., Ltd.), a (meth)acrylate-styrene copolymer (FS series, manufactured by Nippon Paint Co., Ltd.), and polystyrene.

Optionally, a water-soluble substance may be added to an acetal resin such as a polyvinyl butyral resin; a polyamide resin such as nylon; an acrylic resin; a vinyl resin such as a polyvinyl chloride resin, or a polyvinylidene chloride resin; a polyurethane resin; and polyvinyl pyrrolidone, polyethylene glycol, and polyvinyl alcohol.

In the resin particle-dispersed polyimide precursor solution, the content of the resin particles may be in a range from 20% by weight to 600% by weight (preferably in a range from 25% or by weight to 550% by weight, more preferably in a range from 30% by weight to 500% by weight) with respect to 100 parts by weight of the solid content of the polyimide precursor in the polyimide precursor solution.

### Water-Soluble Nonionic Surfactant

As the polyimide precursor solution according to the exemplary embodiment, a water-soluble nonionic surfactant is used. For example, in a case where an anionic surfactant containing a metal ion, there is a possibility that the metal ion may remain in the obtained porous polyimide film. In a case where the porous polyimide film in which the metal ion remains is used for applications such as electrodes of batteries, for example, there is a possibility that defects may occur in the applied products. For this reason, in the polyimide precursor solution of the exemplary embodiment, a water-soluble nonionic surfactant is used.

The water-soluble nonionic surfactant is not particularly limited as long as it is possible to be dissolved in the aqueous solvent including water included in the polyimide precursor solution. Examples of the water-soluble nonionic surfactant include an ester type having a structure in which a polyol such as glycerin, sorbitol and sucrose, and a fatty acid are ester-bonded; an ether type having a structure in which an alkylene oxide such as an ethyne oxide is added to a compound having a hydroxyl group such as a higher alcohol or alkylphenol; and an ester-ether type having a structure in which an alkylene oxide such as an ethine oxide is added to a fatty acid or an ester of a polyol and a fatty acid, and having both of the ester bond and the ether bond in a molecule.

Note that, from the viewpoint of improving the area ratio of the pores on the surface, the surfactant which is easily thermally decomposed may be used.

The water-soluble nonionic surfactant may be a nonionic surfactant which contains at least one kind selected from a fluorine atom or a silicon atom (hereinafter, a nonionic surfactant which contains a fluorine atom may be referred to as “fluorine-containing nonionic surfactant”, and a nonionic surfactant which contains a silicon atom may be referred to as “silicon-nonionic surfactant”).

Examples of the water-soluble nonionic surfactant are described below; however, the water-soluble nonionic surfactant is not limited to the examples.

Examples of the ether type include EMULGEN 103, EMULGEN 705, EMULGEN 709, and EMULGEN LS-114 (which are manufactured by Kao Corporation). Examples of the ester type include RHEODOL SP-L10, RHEODOL SUPER SP-L10, and EMASOL 0-10V (which are manufactured by Kao Corporation).

Examples of ester ⋅ ether type include RHEODOL TW-L120, RHEODOL TW-0106V, and RHEODOL MO-60 (which are manufactured by Kao Corporation).

Examples of the fluorine-containing nonionic surfactant include MEGAFAC (registered trademark) F-410, F-444, F-477, and F-553 (which are manufactured by DIC Corporation), LE-604 and LE-605 (which are manufactured by KYOEISHA CHEMICAL CO., LTD), POLYFOX series of PF-636, PF-6320, PF-656, and PF-6520 (which are manufactured by Omnova Solutions, Inc).

Examples of the silicon-nonionic surfactant include POLYFLOW KL-401, POLYFLOW KL-404 (which are manufactured by KYOEISHA CHEMICAL CO., LTD), BYK-307, BYK-333, and BYK-378 (which are manufactured by BYK-Chemie Japan K.K).

From the viewpoint that the area ratio of the pores on the surface is improved when the porous polyimide film is formed, the content of the water-soluble nonionic surfactant may be in a range from 0.1% by weight to 5.0% by weight (preferably in a range from 0.1% by weight to 4.5% by weight) with respect to the solid content of the resin particles.

Note that, when the content of the water-soluble nonionic surfactant is within a range of 5.0% by weight or less, the area ratio of the pores in the porous film is increased, and defect portions (voids) of the surface of the porous polyimide film is prevented from being easily formed. In addition, the film forming property of the porous film tends to be favorable. If the content of the water-soluble nonionic surfactant is excessively large, the cause is unknown, but there are cases in which defects are liable to occur in the opposite direction.

In the specification, voids refer to defect portions having a size three times or more the average pore diameter on the surface of the porous polyimide film.

### Other Additives

In the method of forming a porous polyimide film according to the exemplary embodiment, the polyimide precursor solution may include a catalyst for promoting the imidization reaction or a leveling agent for improving the quality of the film.

As the catalyst for promoting the imidization reaction, for example, a dehydrating agent such as an acid anhydride, or an acid catalyst such as a phenol derivative, a sulfonic acid derivative, or a benzoic acid derivative may be used.

In addition, depending on the intended use of the porous polyimide film, the polyimide precursor solution may include, for example, a conductive material (which is conductive (for example, a volume resistivity of lower than 10⁷ Ω·cm) or semiconductive (for example, a volume resistivity of from 10⁷ Ω·cm to 10¹³ Ω·cm)) to impart conductivity.

Examples of the conductive material include: carbon blacks (for example, an acidic carbon black having a pH value of 5.0 or lower); metals (for example, aluminum or nickel); metal oxides (for example, yttrium oxide or tin oxide); and ion-conductive materials (for example, potassium titanate or LiCl). Among these conductive materials, one kind may be used alone, or two or more kinds may be used in combination.

In addition, depending on the intended use of the porous polyimide film, the polyimide precursor solution may include inorganic particles which are added to improve the mechanical strength. Examples of the inorganic particles include particulate materials such as silica powder, alumina powder, barium sulfate powder, titanium oxide powder, mica, or talc. In addition, the polyimide precursor solution may include LiCoO₂, LiMn₂O, or the like which is used as an electrode of a lithium ion battery.

### Method of Preparing Polyimide Precursor Solution

A method of preparing the polyimide precursor solution is not particularly limited. For example, the following method may be used.

For example, a method of obtaining a polyimide precursor solution by polymerizing tetracarboxylic dianhydride and a diamine compound in an aqueous solvent in the presence of an organic amine compound to prepare a resin (polyimide precursor) may be used.

According to this method, the aqueous solvent is used. Therefore, there are advantageous effects in that the productivity is high and the polyimide precursor solution is prepared in one stage from the viewpoint of simplifying the process.

In another example of the method, tetracarboxylic dianhydride and a diamine compound are polymerized in an organic solvent such as a polar aprotic solvent (for example, N-methylpyrrolidone (NMP)) to prepare a resin (polyimide precursor), and the resin (polyimide precursor) is poured into an aqueous solvent such as water or alcohol to be deposited. Next, the polyimide precursor and an organic amine compound are dissolved in the aqueous solvent to obtain a polyimide precursor solution.

### Porous Polyimide Film

Next, a porous polyimide film obtained by the polyimide precursor solution according to the exemplary embodiment, and the method of forming a porous polyimide film according to the exemplary embodiment will be described.

The porous polyimide film may be a porous polyimide film which includes an organic amine compound and a resin other than a polyimide resin and does not substantially include a polar aprotic solvent.

The content of the organic amine compound is not particularly limited; however, from the viewpoints of, for example, preventing cracking and controlling the shape of pores, it may be 0.001% by weight or higher with respect to the total weight of the porous polyimide film. By controlling the content of the organic amine compound to be in the above-described range, the cracking of the porous polyimide film is likely to be prevented. Due to the same reason, the lower limit of the content of the organic amine compound is preferably 0.003% by weight or higher, and more preferably 0.005% by weight or higher. In addition, the upper limit of the content of the organic amine compound is not particularly limited; however, it is preferably 1.0% by weight or lower, and more preferably 0.9% by weight or lower.

The content of the organic amine compound in the porous polyimide film may be controlled, for example, by controlling the amount of the organic amine compound used in the first step among the above-described steps of forming a porous polyimide film, the temperature conditions of the heating temperature in the second step, and the like.

From the viewpoints of, for example, preventing cracking and controlling the shape of pores, the content of the resin other than a polyimide resin is preferably from 0.005% by weight to 1% by weight with respect to the total weight of the porous polyimide film. Due to the same reason, the lower limit of the content of the resin other than a polyimide resin is preferably 0.008% by weight or higher, and more preferably 0.01% by weight or higher. In addition, the upper limit of the content of the resin other than a polyimide resin is preferably 1.0% by weight or lower, and more preferably 0.9% by weight or lower.

The content of the resin other than a polyimide resin in the porous polyimide film may be controlled, for example, by controlling the amount of the resin particles used in the first step among the above-described steps of forming a porous polyimide film, the conditions of removing the resin particles in the second step, and the like.

A state where the resin other than a polyimide resin is present in the porous polyimide film is not particularly limited. For example, the resin other than a polyimide resin may be present at least either in the porous polyimide film or on a surface of the porous polyimide film (including surfaces of the pores of the porous polyimide film).

The porous polyimide film does not substantially include a polar aprotic solvent. As described above, “not substantially including” denotes that the content of the polar aprotic solvent is 0.001% by weight or lower. It is more preferable that the polar aprotic solvent is not detected by pyrolysis gas chromatography-mass spectrometry (GC-MS).

Even in a case where the polar aprotic solvent is used in the process of forming the porous polyimide film, the content of the polar aprotic solvent may be controlled by controlling the amount thereof used, the temperature conditions of the heating temperature in the second step, and the like. However, it is preferable that the polar aprotic solvent is not used. Verification of Contents of Organic Amine Compound, Resin other than Polyimide Resin, Fluorine Atom and Silicon Atom of Water-Soluble Nonionic Surfactant, and Polar aprotic solvent

The presence and content of each of the organic amine compound, the polar aprotic solvent, the resin other than the polyimide resin, and the fluorine atom and the silicon atom of the water-soluble nonionic surfactant in the porous polyimide film may be measured, for example, by analyzing and determining components detected by pyrolysis gas chromatography-mass spectrometry (GC-MS). Specifically, the measurement is performed as follows.

Components included in the porous polyimide film are analyzed using a gas chromatography-mass spectrometer (GCMS QP-2010, manufactured by Shimadzu Corporation) equipped with a free-fall pyrolyzer (PY-2020D, manufactured by Frontier Laboratories Ltd.). The organic amine compound and the polar aprotic solvent are determined at a pyrolysis temperature of 400° C. after precisely weighing 0.40 mg of the porous polyimide film. The resin component other than a polyimide resin is determined at a pyrolysis temperature of 600° C. after precisely weighing 0.20 mg of the porous polyimide film. Regarding the resin other than a polyimide resin, a chromatogram at a pyrolysis temperature of 400° C. and a chromatogram at a pyrolysis temperature of 600° C. are compared to each other, and a larger amount of a styrene monomer obtained by depolymerization of polystyrene is detected at a pyrolysis temperature of 600° C. than at a pyrolysis temperature of 400° C. As a result, it is verified that the result is derived from a polymer. Since the surfactant components are difficult to determine, only the presence or absence of the detection of the peak derived from a fluorine compound and a silicon compound is qualitatively analyzed.

Pyrolyzer: PY-2020D, manufactured by Frontier Laboratories Ltd.
Gas chromatography-mass spectrometer: GCMS QP-2010, manufactured by Shimadzu Corporation
Pyrolysis temperature: 400° C., 600° C.
Gas chromatography introduction temperature: 280° C.
Injection method: split ratio=1:50
Column: manufactured by Frontier Laboratories Ltd., Ultra ALLOY-5, 0.25 μm, 0.25 μm ID, 30 m
Gas chromatography temperature program: 40° C.→20° C./min→holding at 280° C. for 10 min
Mass range: EI, m/z=29-600 (the content of the resin other than a polyimide resin)

### Properties of Porous Polyimide Film

The porous polyimide film has pores which have a substantially spherical shape and are linked to each other. In this specification, the meaning of “the shape of pores is substantially spherical” includes both a case where the shape of pores is spherical and a case where the shape of pores is substantially spherical. Specifically, “the shape of pores is substantially spherical” denotes that the proportion of pores, in which a ratio (long diameter/short diameter) of a long diameter to a short diameter, in the porous polyimide film is from 1 to 2 is 50% or higher. As the proportion of the pores increases, the proportion of spherical pores increases. The proportion of pores in which a ratio (long diameter/short diameter) of a long diameter to a short diameter is from 1 to 2 is preferably from 50% to 100%, and more preferably from 55% to 100%. As the ratio of a long diameter to a short diameter of a pore becomes closer to 1, the shape of the pore is more likely to be spherical. Since the pores having a substantially spherical shape are linked to each other, the shape of linked portions is estimated by extrapolation from portions which form walls.

In addition, in a case where the porous polyimide film is applied to, for example, a battery separator of a lithium ion battery, the disruption of ion flow is prevented, and thus the formation of lithium dendrite is likely to be prevented. In addition, in a case where the porous polyimide film is used as a filter, the filtering accuracy (for example, the uniformity in the size of a material included in a filtrate) is improved.

The porous polyimide film is not particularly limited, and preferably, has a porosity of 30% or higher. The porosity is preferably 40% or higher and more preferably 50% or higher. The upper limit of the porosity is not particularly limited and is preferably in a range of 90% or lower.

In addition, the pores may be linked to each other (refer to FIG. 1). For example, the pore diameter of portions where the pores are linked to each other is preferably from 1/100 to ½, more preferably from 1/50 to ⅓, and still more preferably from 1/20 to ¼ with respect to the maximum pore diameter. Specifically, the average pore diameter of portions where the pores are linked to each other is preferably from 5 nm to 1,500 nm.

The average value of the pore diameters is not particularly limited. For example, it may be in a range from 0.1 μm or to 0.5 μm, is preferably in a range from 0.25 μm to 0.5 μm, and is more preferably in a range from 0.25 μm to 0.45

In the porous polyimide film, a ratio of a maximum diameter to a minimum diameter in the pores (a ratio of a maximum pore diameter to a minimum pore diameter) is from 1 to 2. The ratio is preferably from 1 to 1.9 and more preferably from 1 to 1.8. Even in this range, it is still more preferable that the ratio is close to 1. In a case where the ratio is in the above-described range, a variation in the pore diameter is reduced. In addition, in a case where the porous polyimide film according to the exemplary embodiment is applied to, for example, a battery separator of a lithium ion battery, the disruption of ion flow is prevented, and the formation of lithium dendrite is likely to be prevented.

“The ratio of a maximum diameter to a minimum diameter in the pores” is expressed by a value obtained by dividing a maximum diameter by a minimum diameter in the pores (that is, a maximum pore diameter/a minimum pore diameter).

The maximum pore diameter, the minimum pore diameter, the average pore diameter, the average pore diameter of portions where the pores are linked to each other, and the long diameters and short diameters of the pores are values obtained by observation and measurement using a scanning electron microscope (SEM). Specifically, first, the porous polyimide film is cut to prepare a measurement sample. This measurement sample is observed and measured using VE SEM (manufactured by Keyence Corporation) and image processing software as standard equipment thereof. The observation and the measurement are performed on each of 100 pore portions in a cross-section of the measurement sample, and the average diameter, minimum diameter, maximum diameter, and arithmetic average diameter thereof are obtained. In a case where the shape of a pore is not spherical, the length of a longest portion is set as a diameter. A long diameter and a short diameter of each of the pore portions are observed and measured using VE SEM (manufactured by Keyence Corporation) and image processing software as a standard equipment thereof to calculate a ratio (long diameter/short diameter).

The area ratio of the pores on the film surface is observed in five fields of view with SEM, then similarly analyzed with image processing software, and evaluated with the maximum area ratio of the pores, the minimum area ratio of the pores, and the average area ratio of the pores in the five fields of view.

The thickness of the porous polyimide film is not particularly limited and is preferably 15 μm to 500 μm. Application of Porous Polyimide Film

The porous polyimide film may have a single-layer structure or a multi-layer structure including two or more layers. The configuration is not particularly limited as long as it has at least one layer of the porous polyimide film obtained by the method of forming a porous polyimide film of the exemplary embodiment, and it may be a layer structure according to purpose. For example, a porous film having a structure in which a porous polyimide film is laminated with a porous material (for example, at least one of a polyolefin porous film and a nonwoven fabric) may be used.

A laminating method for forming the porous polyimide film according to the exemplary embodiment into a laminated structure is not particularly limited. For example, a known laminating method such as a method of laminating with an adhesive may be exemplified.

### Application of Porous Polyimide Film

Examples of the application to which the porous polyimide film according to the exemplary embodiment is applied include a battery separator such as a lithium battery; a separator for an electrolytic condenser; an electrolyte membrane such as a fuel cell; a battery electrode material; a gas or liquid separation membrane; a low dielectric constant material; and various filters.

In a case where the porous polyimide film according to the exemplary embodiment is applied to the battery separator, for example, it is considered that lithium dendrite is prevented from being formed by the effect of preventing variation in the ion current distribution of lithium ions. The reason for this is presumed that the shape of the pore, the diameter of the pore, and the variation of pore distribution of the porous polyimide film which is included in the porous polyimide film of the exemplary embodiment.

In addition, in a case where the porous film according to the exemplary embodiment is applied to, for example, a battery electrode material, it is thought that the opportunity of contacting an electrolytic solution is increased to thereby increase the battery capacity. The reason for this is presumed that, regarding a material such as carbon black for an electrode which is included in the porous polyimide film, the amount of the material exposed from the surfaces of the pores of the porous polyimide film or from the surface of the film is increased.

Further, for example, a film in which the pores of the porous polyimide film are filled with, for example, an ionic gel obtained by gelation of a so-called ionic liquid may be used as an electrolyte film. Using the method of forming a porous polyimide film according to the exemplary embodiment, the process is simplified. Therefore, it is thought that an electrolyte film may be obtained at a lower cost.

### EXAMPLES

Hereinafter, the invention will be described in more detail using examples but is not limited to these examples. In the following description, unless specified otherwise, “part(s)” and “%” represent “part(s) by weight” and “% by weight”.

### Preparation of Resin Particle-Dispersed Polyimide Precursor Solution (W-1)

1,800 g of water is put into a flask equipped with a stirring rod, a thermometer, and a dropping funnel. 27.28 g (252.27 mmol) of p-phenylenediamine (molecular weight: 108.14) and 50.00 g (494.32 mmol) of N-methylmorpholine (organic amine compound) are added to the flask, and the contents are stirred and dispersed at 20° C. for 10 minutes. Further, 72.72 g (247.16 mmol) of 3,3′,4,4′-biphenyl tetracarboxylic dianhydride (molecular weight: 294.22) is added to the resultant solution, and then while maintaining the reaction temperature at 50° C., the solution is stirred for 24 hours to dissolve the components and to perform a reaction. As a result, a polyimide precursor “water” solution is obtained.

10 parts of a non-crosslinked polymethyl methacrylate-styrene copolymer (FS-102E, manufactured by Nippon Paint Co., Ltd.) having an average particle diameter of 0.1 μm is added to 100 g of the polyimide precursor “water” solution, and the mixture is stirred with a dissolver at 1,500 rpm for 30 minutes. As a result, a resin particle-dispersed polyimide precursor solution (W-1) is obtained. When the dispersion state of the resin particles is measured by COULTER COUNTER LS 13 manufactured by Beckman Coulter Inc., a volume average diameter is 0.52 μm, and two maximum values (peak) of 0.1 μm and 1.05 μm are observed.

### Preparation of Resin Particle-Dispersed Polyimide Precursor Solution (W-2)

71.2 g of methyl methacrylate, 0.21 g of sodium dodecyl sulfate, and 100 parts by weight of ion exchange water are mixed with each other, and the mixture is stirred and emulsified with a dissolver at 1,500 rpm for 30 minutes. As a result, a monomer emulsion is prepared. Next, 480 g of the ion exchange water is put into a reaction container. After heated to 75° C. under nitrogen gas stream, 12 g of the monomer emulsion is added thereinto. Next, a polymerization initiator solution in which 1 g of ammonium persulfate is dissolved in 20 g of ion exchange water is added dropwise to the monomer emulsion for 10 minutes.

After performing the reaction for 50 minutes after the dropwise addition, the remaining monomer emulsion is further added dropwise over 220 minutes, and the reaction is further performed for 180 minutes, thereby obtaining a resin particle dispersion (1) as an acrylic resin particle dispersion. The average particle diameter of the resin particles is 300 nm.

After cooling the resin particle dispersion (1) to 50° C., p-phenylenediamine (molecular weight 108.14): 8.1 g (70 mmol) and N-methylmorpholine (organic amine compound): 23.3 g (23 mmol) are added to the resin particle dispersion, and the mixture is stirred and dispersed at 50° C. for 10 minutes. Further, 3,3′,4,4′-biphenyl tetracarboxylic dianhydride (molecular weight 294.22): 22.6 g (80 mmol) is added to the above obtained solution, and the mixture is allowed to react at 50° C. for 10 hours. As a result, a resin particle-dispersed polyimide precursor solution (W-2) is obtained.

A dispersion state of the resin particles is measured by COULTER COUNTER LS 13 manufactured by Beckman Coulter Inc., Ltd. in the same manner as in the evaluation of the dispersion state of the resin particles in the polyimide precursor solution in each example described later. As a result, the volume average diameter is 1.58 μm, and two maximum values (peak) at 0.31 μm and 2.10 μm are observed.

### Example 1

0.01 g of fluorine-containing nonionic surfactant, MEGAFAC (registered trademark) F-410, is added to 10 g of resin particle-dispersed polyimide precursor solution (W-1), and the mixture is stirred with a dissolver at 1,500 rpm for 30 minutes. As a result, a polyimide precursor solution in which the resin particles of Example 1 are dispersed is obtained. The obtained solution is defoamed under the reduced pressure, a glass plate is coated with the solution, and the coated glass plate is dried at 80° C. for one hour. After that, the coated glass plate is heated to 400° C. over one hour, is held for one hour, and then cooled, and being peeled off from the glass substrate, a porous polyimide film (PIF-1) having a film thickness of 20 μm is obtained.

### Example 2

A porous polyimide film (PIF-2) having a film thickness of 20 μm is obtained in the same manner as in Example 1 except that 0.02 g of fluorine-containing nonionic surfactant, MEGAFAC (registered trademark) F-410, is added to 10 g of resin particle-dispersed polyimide precursor solution (W-1).

### Example 3

A porous polyimide film (PIF-3) having a film thickness of 20 μm is obtained in the same manner as in Example 1 except that 0.04 g of fluorine-containing nonionic surfactant, MEGAFAC (registered trademark) F-410, is added to 10 g of resin particle-dispersed polyimide precursor solution (W-1).

### Comparative Example 1

A porous polyimide film (RPIF-1) having a film thickness of 20 μm is obtained in the same manner as in Example 1 except that fluorine-containing nonionic surfactant, MEGAFAC (registered trademark) F-410, is not added.

### Example 11

A porous polyimide film (PIF-11) having a film thickness of 20 μm is obtained in the same manner as in Example 1 except that 0.06 g of fluorine-containing nonionic surfactant, MEGAFAC (registered trademark) F-410, is added.

### Example 4

0.01 g of silicon-nonionic surfactant, POLYFLOW KL-401, is added to 10 g of resin particle-dispersed polyimide precursor solution (W-2), and the mixture is stirred with a dissolver at 1,500 rpm for 30 minutes. As a result, a polyimide precursor solution in which the resin particles of Example 4 are dispersed is obtained. The obtained solution is defoamed under the reduced pressure, a glass plate is coated with the solution, and the coated glass plate is dried at 80° C. for one hour. After that, the coated glass plate is heated to 400° C. over one hour, is held for one hour, and then cooled, and being peeled off from the glass substrate, a porous polyimide film (PIF-4) having a film thickness of 20 μm is obtained.

### Example 5

A porous polyimide film (PIF-5) having a film thickness of 20 μm is obtained in the same manner as in Example 4 except that 0.02 g of silicon-nonionic surfactant, POLYFLOW KL-401, is added to 10 g of resin particle-dispersed polyimide precursor solution (W-1).

### Example 6

A porous polyimide film (PIF-6) having a film thickness of 20 μm is obtained in the same manner as in Example 4 except that 0.04 g of silicon-nonionic surfactant, POLYFLOW KL-401, is added to 10 g of resin particle-dispersed polyimide precursor solution (W-1).

### Comparative Example 2

A porous polyimide film (RPIF-2) having a film thickness of 20 μm is obtained in the same manner as in Example 4 except that the silicon-nonionic surfactant, POLYFLOW KL-401, is not added.

### Example 12

A porous polyimide film (PIF-12) having a film thickness of 20 μm is obtained in the same manner as in Example 4 except that 0.06 g of silicon-nonionic surfactant, POLYFLOW KL-401, is added.

### Examples 7 to 10

Porous polyimide films PIF-7 to PIF-10 are prepared in the same manner as in Example 5 except that EMULGEN 103, EMASOL 0-10V, PF-6520, and BYK-307 are used as the water-soluble nonionic surfactant, respectively.

### Examples 13 and 14

PIF-13 and PIF-14 are prepared in the same manner as in Examples 1 and 4 except for adding NMP (N-methylpyrrolidone) so as to provide a concentration of 5% by weight with respect to water, respectively.

### Preparation of Resin Particle-Dispersed Polyimide Precursor Solution (W-3)

71.2 g of methyl methacrylate, 0.10 g of sodium dodecyl sulfate, and 100 parts by weight of ion exchange water are mixed with each other, and the mixture is stirred and emulsified with a dissolver at 1,500 rpm for 30 minutes. As a result, a monomer emulsion is prepared. Next, 480 g of the ion exchange water is put into a reaction container. After heated to 75° C. under nitrogen gas stream, 12 g of the monomer emulsion is added. Next, a polymerization initiator solution in which 1 g of ammonium persulfate is dissolved in 20 g of ion exchange water is added dropwise to the monomer emulsion over 10 minutes. After performing the reaction for 50 minutes after the dropwise addition, the remaining monomer emulsion is further added dropwise over 220 minutes, and the reaction is further performed for 180 minutes, thereby obtaining a resin particle dispersion (1) as an acrylic resin particle dispersion. The average particle diameter of the resin particles is 440 nm.

After cooling the resin particle dispersion (1) to 50° C., p-phenylenediamine (molecular weight 108.14): 8.1 g (70 mmol) and N-methylmorpholine (organic amine compound): 23.3 g (23 mmol) are added to the resin particle dispersion, and the mixture is stirred and dispersed at 50° C. for 10 minutes. Further, 3,3′,4,4′-biphenyl tetracarboxylic dianhydride (molecular weight 294.22): 22.6 g (80 mmol) is added to the above obtained solution, and the mixture is allowed to react at 50° C. for 10 hours. As a result, a resin particle-dispersed polyimide precursor solution (W-3) is obtained.

A dispersion state of the resin particles is measured by COULTER COUNTER LS 13 manufactured by Beckman Coulter Inc. in the same manner as in the evaluation of the dispersion state of the resin particles in the polyimide precursor solution in each example described later. As a result, the volume average diameter is 1.82 μm, and two maximum values (peak) at 0.44 μm and 2.50 μm are observed.

### Example 15

A PIF-15 is prepared in the same manner as in Example 1 except that the resin particle-dispersed polyimide precursor solution (W-3) is used.

### Evaluation

### Evaluation of Dispersion State of Resin Particles in Polyimide Precursor Solution

Regarding the dispersion state of the resin particles in the polyimide precursor solution which is obtained in each example, the measurement is performed by COULTER COUNTER LS 13 manufactured by Beckman Coulter Inc. For the measurement, the polyimide precursor obtained each example is diluted with water. Regarding the volume average particle diameter of the resin particles in the polyimide precursor solution, a volume cumulative distribution is drawn on divided particle diameter ranges (channels) based on the measured particle diameter distribution in order from the smallest particle diameter, and a particle diameter having a cumulative value of 50% is defined as a volume average particle diameter. In addition, in the particle diameter distribution, a particle diameter corresponding to the maximum value (peak) is measured. The results are shown in Table 1.

### Evaluation of Area Ratio of Pores on Surface

The porous polyimide film obtained in each example is observed in five fields of view with SEM, and maximum area ratio of the pores, the minimum area ratio of the pores, the average area ratio of the pores, and the number of voids are evaluated. The results are shown in Table 2.

### Evaluation of Pore Diameter Distribution

Regarding the porous polyimide film obtained in each example, the pore diameter distribution is evaluated (the ratio of a long diameter to a short diameter are evaluated). Specifically, the evaluation is performed using the above-described method. The results are shown in Table 2.

### Evaluation of Defect Portions (Voids)

Regarding the porous polyimide film obtained in each example, the voids are evaluated. A defect portion having a size three times or more the average pore diameter on the surface of the porous polyimide film is designated as a void while performing the observation in five fields of view with the above-described SEM, and then the evaluation is performed based on the following evaluation criteria. The results are shown in Table 2.

### Evaluation Criteria

A: No void is observed on all the five fields of view.
B: Number of fields of view on which at least one void is observed is from 1 to 3.
C: Number of fields of view on which at least one void is observed is 4 or 5.
Analysis of Organic Amine Compound, Resin Other than Polyimide Resin, and F and Si Compounds

According to the above-described method, the presence, the absence, and the content of each component are measured by GC-MS. The results are shown in Table 2.

TABLE 1

| | | | | | | | Particle diameter distribution of resin | | |
|---|---|---|---|---|---|---|---|---|---|
| | | | | | | | particles (μm) | | |
| | | | | | | | Volume | | |
| | | Resin | Resin particles | | Nonionic surfactant | | average | Maximum | Maximum |
| | Porous PI | particle-dispersed PI | | Particle | | Content | particle | value | value |
| | film | precursor solution | Kinds | diameter (μm) | Kinds | (% by weight) | diameter | diameter 1 | diameter 2 |
| Example 1 | PIF-1 | W-1 | PMMA/St | 0.1 | F-410 | 0.01 g | 0.32 | 0.10 | 0.85 |
| | | | | | | (1.1%) | | | |
| Example 2 | PIF-2 | W-1 | PMMA/St | 0.1 | F-410 | 0.02 g | 0.13 | 0.10 | 0.20 |
| | | | | | | (2.2%) | | | |
| Example 3 | PIF-3 | W-1 | PMMA/St | 0.1 | F-410 | 0.04 g | 0.10 | 0.10 | — |
| | | | | | | (4.4%) | | | |
| Example 4 | PIF-4 | W-2 | PMMA | 0.3 | KL-401 | 0.01 g | 1.18 | 0.31 | 1.60 |
| | | | | | | (1.0%) | | | |
| Example 5 | PIF-5 | W-1 | PMMA/St | 0.1 | KL-401 | 0.02 g | 0.65 | 0.31 | 0.96 |
| | | | | | | (2.2%) | | | |
| Example 6 | PIF-6 | W-1 | PMMA/St | 0.1 | KL-401 | 0.04 g | 0.31 | 0.31 | — |
| | | | | | | (4.4%) | | | |
| Example 7 | PIF-7 | W-1 | PMMA/St | 0.1 | EMULGEN 103 | 0.02 g | 0.85 | 0.31 | 1.15 |
| | | | | | | (2.0%) | | | |
| Example 8 | PIF-8 | W-1 | PMMA/St | 0.1 | EMASOL O-10V | 0.02 g | 0.75 | 0.31 | 1.06 |
| | | | | | | (2.0%) | | | |
| Example 9 | PIF-9 | W-1 | PMMA/St | 0.1 | PF-6520 | 0.02 g | 0.78 | 0.31 | 1.09 |
| | | | | | | (2.0%) | | | |
| Example 10 | PIF-10 | W-1 | PMMA/St | 0.1 | BYK-307 | 0.02 g | 0.81 | 0.31 | 1.07 |
| | | | | | | (2.0%) | | | |
| Example 11 | PIF-11 | W-1 | PMMA/St | 0.1 | F-410 | 0.06 g | 0 10 | 0 10 | — |
| | | | | | | (6.6%) | | | |
| Example 12 | PIF-12 | W-2 | PMMA | 0.3 | KL-401 | 0.06 g | 0.31 | 0.31 | — |
| | | | | | | (5.9%) | | | |
| Example 13 | PIF-13 | W-1 + NMP | PMMA/St | 0.1 | F-410 | 0.01 g | 0.31 | 0 10 | 0.79 |
| | | | | | | (1.1%) | | | |
| Example 14 | PIF-14 | W-2 + NMP | PMMA | 0.3 | KL-401 | 0.01 g | 1.15 | 0.30 | 1.51 |
| | | | | | | (1.0%) | | | |
| Example 15 | PIF-15 | W-3 | PMMA | 0.44 | F-410 | 0.01 g | 0.49 | 0.44 | 1.89 |
| | | | | | | (1.1%) | | | |
| Comparative | RPIF-1 | W-1 | PMMA/St | 0.1 | — | — | 0.52 | 0.10 | 1.05 |
| Example 1 | | | | | | | | | |
| Comparative | RPIF-2 | W-2 | PMMA | 0.3 | — | — | 1.58 | 0.31 | 2.10 |
| Example 2 | | | | | | | | | |

TABLE 2

| | | | | | Ratio of pores | | Content | Monomer derived | |
|---|---|---|---|---|---|---|---|---|---|
| | | | | | having a long | | of organic | from resin soluble in | |
| | Porous | Area ratio of | | | diameter/short | | amine compound | solvent in which PI | Detect |
| | polyimide | pores on surface (%) | | | diameter of 1 to 2 | Evaluation | (% by | resin is not dissolved | F and Si |
| | film | Maximum | Minimum | Average | (%) | of voids | weight) | (% by weight) | compounds |
| Example 1 | PIF-1 | 25 | 15 | 20 | 95 | A | 0.010 | 0.013 | Detected |
| Example 2 | PIF-2 | 26 | 17 | 22 | 95 | A | 0.015 | 0.012 | Detected |
| Example 3 | PIF-3 | 29 | 21 | 25 | 96 | A | 0.011 | 0.009 | Detected |
| Example 4 | PIF-4 | 30 | 15 | 23 | 96 | A | 0.011 | 0.012 | Detected |
| Example 5 | PIF-5 | 31 | 17 | 25 | 96 | A | 0.010 | 0.009 | Detected |
| Example 6 | PIF-6 | 32 | 21 | 27 | 98 | A | 0.010 | 0.013 | Detected |
| Example 7 | PIF-7 | 28 | 17 | 23 | 90 | A | 0.011 | 0.011 | Not detected |
| Example 8 | PIF-8 | 28 | 16 | 22 | 92 | A | 0.012 | 0.01 | Not detected |
| Example 9 | PIF-9 | 29 | 17 | 23 | 91 | A | 0.010 | 0.011 | Not detected |
| Example 10 | PIF-10 | 29 | 18 | 24 | 90 | A | 0.011 | 0.010 | Not detected |
| Example 11 | PIF-11 | 29 | 21 | 25 | 94 | C | 0.011 | 0.011 | Detected |
| | | | | | Defected | | | | |
| Example 12 | PIF-12 | 32 | 21 | 27 | 95 | B | 0.011 | 0.013 | Detected |
| | | | | | Defected | | | | |
| Example 13 | PIF-13 | 26 | 18 | 22 | 93 | A | 0.010 | 0.013 | Detected |
| Example 14 | PIF-14 | 32 | 19 | 25 | 92 | A | 0.011 | 0.012 | Detected |
| Example 15 | PIF-15 | 33 | 23 | 26 | 95 | A | 0.010 | 0.011 | Detected |
| Comparative | RPIF-1 | 20 | 13 | 16 | 83 | A | 0.010 | 0.011 | Not detected |
| Example 1 | | | | | | | | | |
| Comparative | RPIF-2 | 29 | 11 | 18 | 93 | A | 0.012 | 0.012 | Not detected |
| Example 2 | | | | | | | | | |

From the above-described results, it is understood that evaluation result of the area ratio of the pores on the surface is satisfactory in Examples as compared with Comparative Examples.

Hereinafter, the details of abbreviations in Tables 1 and 2 will be shown.

“PMMA/St”: non-crosslinked polymethyl methacrylate.styrene copolymer

“PMMA”: non-crosslinked polymethyl methacrylate polymer

“PI”: polyimide

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A polyimide precursor solution comprising:
resin particles;
an aqueous solvent including water;
a polyimide precursor;
an organic amine compound; and
a water-soluble nonionic surfactant.

2. The polyimide precursor solution according to claim 1,
wherein a content of the water-soluble nonionic surfactant is in a range from 0.1% by weight to 5.0% by weight with respect to a solid content of the resin particles.

3. The polyimide precursor solution according to claim 2,
wherein the content of the water-soluble nonionic surfactant is in a range from 0.1% by weight to 4.5% by weight with respect to the solid content of the resin particles.

4. The polyimide precursor solution according to claim 1,
wherein an average particle diameter of the resin particles is in a range from 0.1 μm to 0.5 μm.

5. The polyimide precursor solution according to claim 4,
wherein the average particle diameter of the resin particles is in a range from 0.25 μm to 0.5 μm.

6. The polyimide precursor solution according to claim 1,
wherein a content of the resin particles is in a range from 20 parts by weight to 600 parts by weight with respect to 100 parts by weight of a solid content of the polyimide precursor.

7. The polyimide precursor solution according to claim 6,
wherein the content of the resin particles is in a range from 30 parts by weight to 500 parts by weight with respect to 100 parts by weight of the solid content of the polyimide precursor.

8. The polyimide precursor solution according to claim 1,
wherein the aqueous solvent includes water in a range from 50% by weight to 100% by weight with respect to a total content of the aqueous solvent.

9. The polyimide precursor solution according to claim 8,
wherein the aqueous solvent includes water in a range from 80% by weight to 100% by weight with respect to the total content of the aqueous solvent.

10. The polyimide precursor solution according to claim 1,
wherein the water-soluble nonionic surfactant is a nonionic surfactant having an atom including at least one selected from the group consisting of a fluorine atom and a silicon atom.

11. The polyimide precursor solution according to claim 1,
wherein the organic amine compound is a tertiary amine compound.

12. The polyimide precursor solution according to claim 11,
wherein the organic amine compound is at least one selected from the group consisting of 2-dimethylaminoethanol, 2-diethylaminoethanol, 2-dimethylaminopropanol, pyridine, triethylamine, picoline, N-methylmorpholine, N-ethylmorpholine, 1,2-dimethylimidazole, 2-ethyl-4-methylimidazole, N-methylpiperidine, and N-ethylpiperidine.

13. The polyimide precursor solution according to claim 12,
wherein the organic amine compound is an amine compound having a morpholine skeleton.

14. A method of forming a porous polyimide film, comprising:
forming a film including a polyimide precursor and resin particles by applying a polyimide precursor solution including an aqueous solvent including water, resin particles which are not dissolved in the aqueous solvent, an organic amine compound, a polyimide precursor, and a water-soluble nonionic surfactant to prepare a coated film, and then drying the coated film; and
forming a polyimide film by heating the film to imidize the polyimide precursor, which includes a treatment of removing the resin particles.
